(19) United States
(12) Patent Application Publication
(10) Pub. No.: US 2013/0290363 A1
(43) Pub. Date: Oct. 31, 2013

(54) RICH USER DESCRIPTIONS FOR SOCIAL NETWORK

(71) Applicant: ELECTRONICS AND TELECOMMUNICATIONS RESEARCH INSTITUTE, Daejeon (KR)

(72) Inventors: Sang Hyun JOO, Daejeon (KR); Soo Min LIM, Incheon (KR); Si Hwan JANG, Seoul (KR); Heong Joong KIM, Seoul (KR); IL Kwon JEONG, Daejeon (KR); Bon Ki KOO, Daejeon (KR)

(73) Assignee: Electronics and Telecommunications Research Institute, Daejeon (KR)

(21) Appl. No.: 13/871,933

(22) Filed: Apr. 26, 2013

(30) Foreign Application Priority Data
Apr. 26, 2012 (KR) 10-2012-0043677

(51) Int. Cl. G06F 17/30

(52) U.S. Cl. CPC G06F 17/30386
USPC 707/758

(57) ABSTRACT

Provided is a method of managing contents in a social networking service, the method including storing information about each of a plurality of users participating in the social networking service, in a table structured based on a predetermined syntax, receiving a search request from a first user among the plurality of users, providing the first user with contents owned by a second user, as a search result corresponding to the search request, by referring to the structured table, receiving an additional search request from the first user, and providing the first user with additional contents owned by the second user, as a search result corresponding to the search request, by referring to the structured table.

### CROSS-REFERENCE TO RELATED APPLICATION

This application claims the benefit of Korean Patent Application No. 10-2012-0043677, filed on Apr. 26, 2012, in the Korean Intellectual Property Office, the disclosure of which is incorporated herein by reference.

### BACKGROUND

1. Field of the Invention

The present invention relates to rich user descriptions for a social network.

2. Description of the Related Art

Recently, technologies for social networking services are garnering attention. Users express their opinions or share varied information through social networking services, such as Facebook, and Twitter.

However, a great volume of information exists on a social network. Due to the large volume of information, users may experience difficulty in obtaining appropriate information within the social network, at a proper time.

### SUMMARY

According to an aspect of the present invention, there is provided a method of managing contents in a social networking service, the method including storing information about each of a plurality of users participating in the social networking service, in a table structured based on a predetermined syntax, receiving a search request from a first user among the plurality of users, providing the first user with contents owned by a second user, as a search result corresponding to the search request, by referring to the structured table, receiving an additional search request from the first user, and providing the first user with additional contents owned by the second user, as a search result corresponding to the search request, by referring to the structured table.

The method may further include searching for the contents owned by the second user, using information included in a table structured based on a syntax predetermined for each of the plurality of users, in response to the search request received from the first user.

The method may further include searching for the additional contents owned by the second user, using information included in a table structured based on a syntax predetermined for each of the plurality of users, in response to the additional search request received from the first user.

The method may further include determining whether the additional contents owned by the second user is to be provided to the first user, using information included in a table structured based on a syntax predetermined for each of the plurality of users.

The table may include an attributes field including information about an identification(ID) for each of the plurality of users with respect to the social networking service, a gender, a date of birth, a last name, and a first name for each of the plurality of users.

The table may include a profile field including at least one of a photo, a height, a weight, an address, phone numbers, an email address, and a fax number for each of the plurality of users.

The table may include a user status field including at least one of a location, an emotion, a blood pressure, and a heart rate for each of the plurality of users.

The table may include a user activity field including at least one of an office, a school, a lecture, a class, a club, a homepage, a blog, and a religion for each of the plurality of users.

The table may include a user interest field including at least one of cooking, baking, gaming, and driving for each of the plurality of users.

The table may include a user history field including at least one of a medical record, a criminal record, an accident record, an insurance record, an educational record, and an academic record for each of the plurality of users.

The table may include a using contents field including at least one of a text, an image, audio contents, and a movie that are used by each of the plurality of users.

The table may include a user certificate field including at least one of a driver's license, a teacher's license, and a diploma for each of the plurality of users.

The table may include a user communication field including at least one of a speech, a gesture, a wiring, and a touch, as means of communication for each of the plurality of users.

The table may include a user device field including at least one of a smart phone, a tablet personal computer (PC), a car, and a navigation system, as devices for each of the plurality of users.

The table may include a social networks field including at least one of a family, a friend, a follower, and a followee, as social relations for each of the plurality of users.

The table may include a social aspect field including at least one of credits, assets, and an authority, as social aspects for each of the plurality of users.

### EFFECT OF THE INVENTION

According to example embodiments, rich user descriptions by which a user may obtain necessary information, among information exiting in a social network at a proper time, in a proper manner.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a social network according to an embodiment of the present invention;

FIG. 2 is a diagram illustrating an attributes field in a table structured based on a predetermined syntax according to an embodiment of the present invention;

FIG. 3 is a diagram illustrating a profile field in a table structured based on a predetermined syntax according to an embodiment of the present invention;

FIG. 4 is a diagram illustrating a user status field in a table structured based on a predetermined syntax according to an embodiment of the present invention;

FIG. 5 is a diagram illustrating a user activity field in a table structured based on a predetermined syntax according to an embodiment of the present invention;

FIG. 6 is a diagram illustrating a user interest field in a table structured based on a predetermined syntax according to an embodiment of the present invention;

FIG. 7 is a diagram illustrating a user history field in a table structured based on a predetermined syntax according to an embodiment of the present invention;

FIG. 8 is a diagram illustrating a using contents field in a table structured based on a predetermined syntax according to an embodiment of the present invention;

FIG. 9 is a diagram illustrating a user certificate field in a table structured based on a predetermined syntax according to an embodiment of the present invention;

FIG. 10 is a diagram illustrating a user communication field in a table structured based on a predetermined syntax according to an embodiment of the present invention;

FIG. 11 is a diagram illustrating a user device field in a table structured based on a predetermined syntax according to an embodiment of the present invention;

FIG. 12 is a diagram illustrating a social networks field in a table structured based on a predetermined syntax according to an embodiment of the present invention; and

FIG. 13 is a diagram illustrating a social aspect field in a table structured based on a predetermined syntax according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

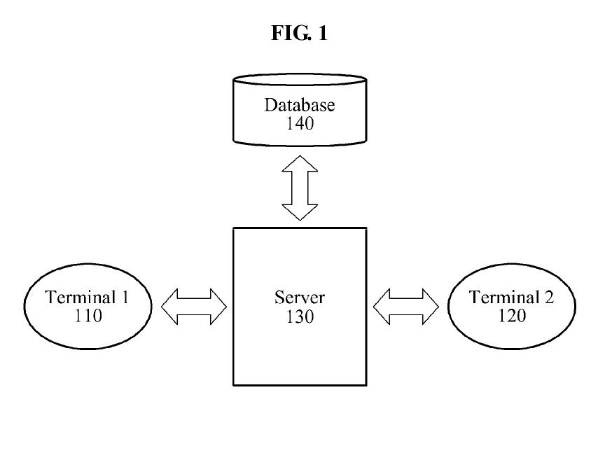

FIG. 1 is a diagram illustrating a social network according to an embodiment of the present invention.

Referring to FIG. 1, the social network may include a terminal 110 of a first user, a terminal 120 of a second user, a server 130, and a database 140.

The database 140 may store information about each of a plurality of users participating in a social networking service in a table structured based a predetermined syntax. Information included in the table, and the syntax of the table will be described later.

When the server 130 receives a search request from the terminal 110 of the first user, the server 130 may provide the terminal 110 of the first user with contents owned by the second user, as a search result corresponding to the search request, by referring to the table stored in the database 140.

In this instance, the server 130 may provide contents desired by the first user rapidly and accurately, by referring to a table with respect to the first user and tables with respect to other users that are pre-stored in the database 140. For example, the server 130 may provide the contents desired by the first user rapidly, by referring to various fields, for example, an interest field, a user status field, and the like, Hereinafter, it may be assumed that contents provided in response to the search request from the first user corresponds to contents owned by the second user.

The contents provided in response to the search request from the first user may correspond to contents set to “public” by the second user. In this instance, the first user may access or utilize the contents, without authorization. When additional information is desired by the first user, the first user may transmit an additional search request.

In this instance, the server 130 may search for additional contents owned by the second user, by referring to the structured table. However, an approval of the second user may be necessary with respect to the additional contents. When the approval of the second user is necessary, the first user may transmit an approval request to the second user, and the additional contents may be provided to the first user, depending on whether the second user approves the approval request.

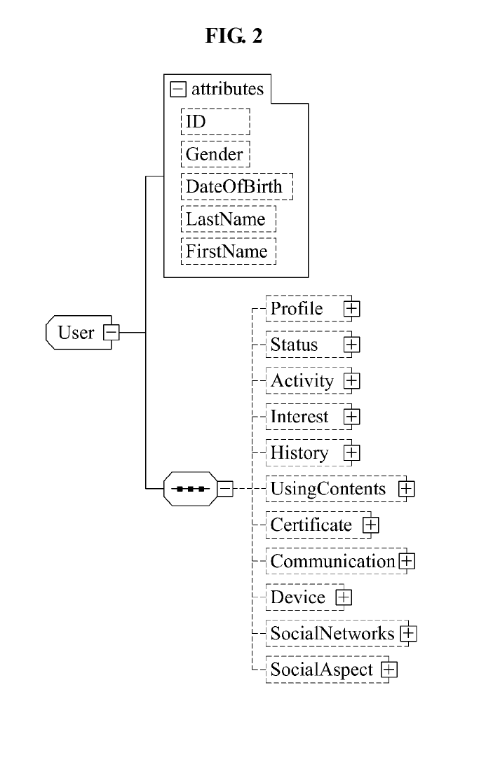

FIG. 2 is a diagram illustrating an attributes field in a table structured based on a predetermined syntax according to an embodiment of the present invention.

Referring to FIG. 2, the attributes field may describe intrinsic information of users. Here, attributes may be changeable. The attributes field may include information about a gender, a date of birth, a last name, and a first name for each of a plurality of users.

The server 130 of FIG. 1 may identify users participating in a social networking service, and an owner of contents, by referring to the attributes field.

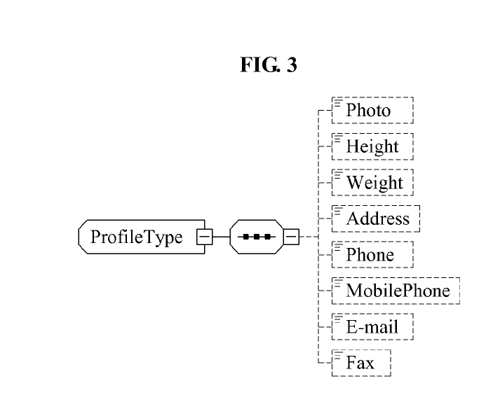

FIG. 3 is a diagram illustrating a profile field in a table structured based on a predetermined syntax according to an embodiment of the present invention.

Referring to FIG. 3, the profile field may include a photo, a height, a weight, an address, phone numbers, an email address, and a fax number for each of a plurality of users. The plurality of users may recognize a predetermined user using the profile field.

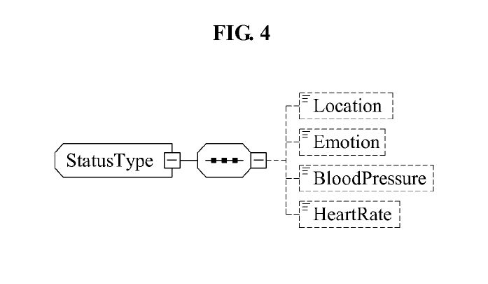

FIG. 4 is a diagram illustrating a user status field in a table structured based on a predetermined syntax according to an embodiment of the present invention.

Referring to FIG. 4, the user status field may include a location, an emotion, a blood pressure, and a heart rate for each of a plurality of users.

The user status field may describe a current status for each of the plurality of users. An extra authorizing system for a predetermined user, such as civil servants, like emergency medical technicians (EMTs), a policeman, and the like may exist. In this instance, the public authorized people may know a location, an emotion, a blood pressure, a heart rate of another user, using the user status field. For example, when search requests are received from the civil servants, a server may provide proper search results, by referring to a user status field for each user.

As another example, when a user is in an unconscious state by accident, a personal system of the user may recognize the situation, and may deliver an emergency message to other nearby users.

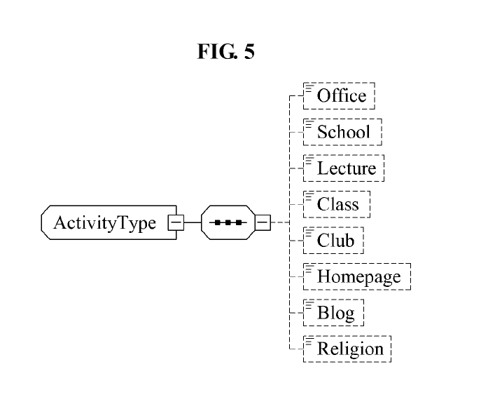

FIG. 5 is a diagram illustrating a user activity field in a table structured based on a predetermined syntax according to an embodiment of the present invention.

Referring to FIG. 5, the user activity field may include an office, a school, a lecture, a class, a club, a homepage, a blog, and a religion for each of a plurality of users. The user activity field may describe online activities or offline activities that each of the plurality of users is involved in.

For example, when a Christian user transmits a search request associated with a religion, a server may search for contents owned by users having “Christianity” as a religion, with priority, by referring to a user activity field for each of the plurality of users.

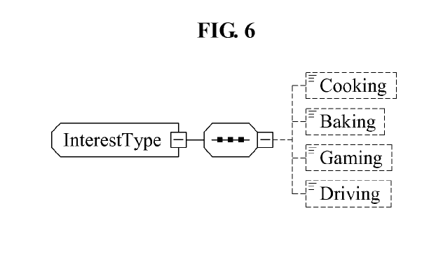

FIG. 6 is a diagram illustrating a user interest field in a table structured based on a predetermined syntax according to an embodiment of the present invention.

Referring to FIG. 6, the user interest field may include cooking, baking, gaming, or driving with respect to each of the plurality of users. That is, the user interest field may describe interests of a user within a social community.

For example, when a search request associated with games is received, a server may search for contents owned by users whose hobbies are gaming, with priority, by referring to the user interest field.

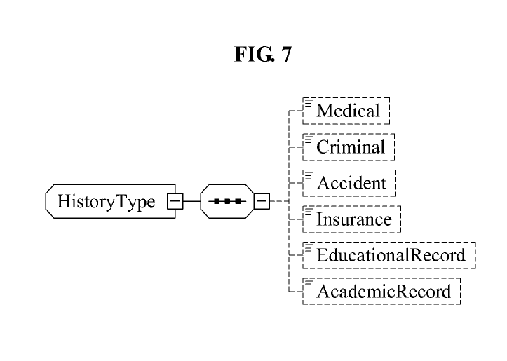

FIG. 7 is a diagram illustrating a user history field in a table structured based on a predetermined syntax according to an embodiment of the present invention.

Referring to FIG. 7, the user history field may include a medical record, a criminal record, an accident record, an insurance record, and an educational or academic record for each of a plurality of users.

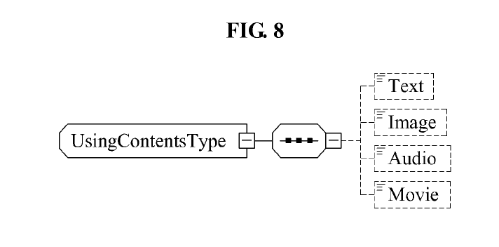

FIG. 8 is a diagram illustrating a using contents field in a table structured based on a predetermined syntax according to an embodiment of the present invention.

Referring to FIG. 8, the using contents field may include a text, an image, audio contents, or a movie that are used by each of a plurality of users.

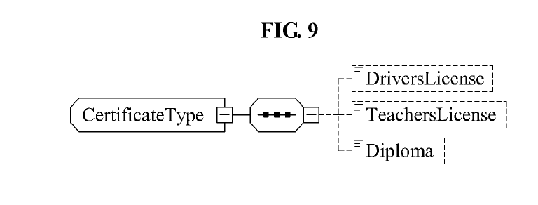

FIG. 9 is a diagram illustrating a user certificate field in a table structured based on a predetermined syntax according to an embodiment of the present invention.

Referring to FIG. 9, the user certificate field may include at least one of a driver's license, a teacher's license, and a diploma for each of a plurality of users.

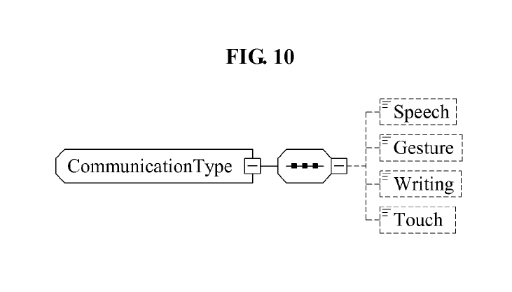

FIG. 10 is a diagram illustrating a user communication field in a table structured based on a predetermined syntax according to an embodiment of the present invention.

Referring to FIG. 10, the user communication field may include at least one of a speech, a gesture, a wiring, and a touch, as means of communication for each of a plurality of users.

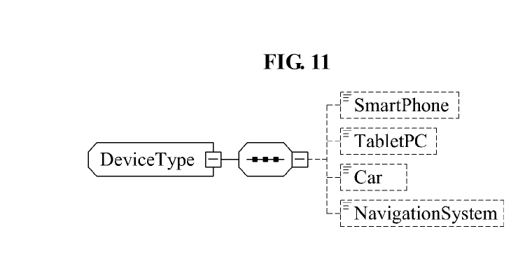

FIG. 11 is a diagram illustrating a user device field in a table structured based on a predetermined syntax according to an embodiment of the present invention.

Referring to FIG. 11, the user device field may include at least one of a smart phone, a tablet personal computer (PC), a car, and a navigation system, as devices for each of a plurality of users.

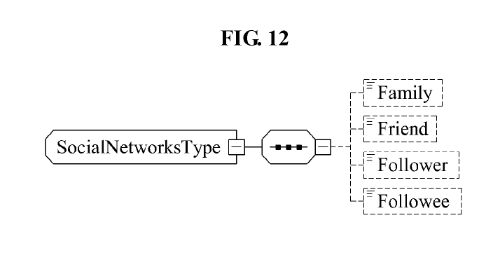

FIG. 12 is a diagram illustrating a social networks field in a table structured based on a predetermined syntax according to an embodiment of the present invention.

Referring to FIG. 12, the social networks field may include at least one of a family, a friend, a follower, and a followee, as social relationships for each of a plurality of users. The social networks field may describe social online networks or social offline networks of a user. An authorizing system may be constructed based on information categorized in a manner described above. Here, the family may describe other users that are strongly acquainted with the user, and may include a physical family as well. The friend may describe other users being acquainted with the user. The follower may describe other users who the user wants to follow. The followee may describe other users who want to follow the user.

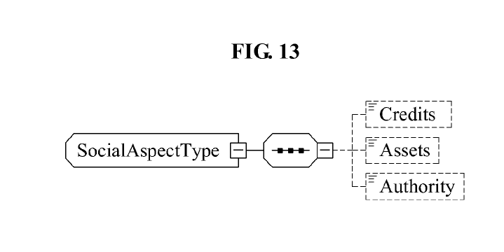

FIG. 13 is a diagram illustrating a social aspect field in a table structured based on a predetermined syntax according to an embodiment of the present invention.

Referring to FIG. 13, the social aspect field may include at least one of credits, assets, and an authority, as social aspects for each of the plurality of users.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of managing contents in a social networking service, the method comprising:
storing information about each of a plurality of users participating in the social networking service, in a table structured based on a predetermined syntax;
receiving a search request from a first user among the plurality of users;
providing the first user with contents owned by a second user, as a search result corresponding to the search request, by referring to the structured table;
receiving an additional search request from the first user; and
providing the first user with additional contents owned by the second user, as a search result corresponding to the search request, by referring to the structured table.

2. The method of claim 1, further comprising:
searching for the contents owned by the second user, using information included in a table structured based on a syntax predetermined for each of the plurality of users, in response to the search request received from the first user.

3. The method of claim 1, further comprising:
searching for the additional contents owned by the second user, using information included in a table structured based on a syntax predetermined for each of the plurality of users, in response to the additional search request received from the first user.

4. The method of claim 1, further comprising:
determining whether the additional contents owned by the second user is to be provided to the first user, using information included in a table structured based on a syntax predetermined for each of the plurality of users.

5. The method of claim 1, wherein the table comprises an attributes field comprising information about an identification (ID) for each of the plurality of users with respect to the social networking service, a gender, a date of birth, a last name, and a first name for each of the plurality of users.

6. The method of claim 1, wherein the table comprises a profile field comprising at least one of a photo, a height, a weight, an address, phone numbers, an email address, and a fax number for each of the plurality of users.

7. The method of claim 1, wherein the table comprises a user status field comprising at least one of a location, an emotion, a blood pressure, and a heart rate for each of the plurality of users.

8. The method of claim 1, wherein the table comprises a user activity field comprising at least one of an office, a school, a lecture, a class, a club, a homepage, a blog, and a religion for each of the plurality of users.

9. The method of claim 1, wherein the table comprises a user interest field comprising at least one of cooking, baking, gaming, and driving for each of the plurality of users.

10. The method of claim 1, wherein the table comprises a user history field comprising at least one of a medical record, a criminal record, an accident record, an insurance record, an educational record, and an academic record for each of the plurality of users.

11. The method of claim 1, wherein the table comprises a using contents field comprising at least one of a text, an image, audio contents, and a movie that are used by each of the plurality of users.

12. The method of claim 1, wherein the table comprises a user certificate field comprising at least one of a driver's license, a teacher's license, and a diploma for each of the plurality of users.

13. The method of claim 1, wherein the table comprises a user communication field comprising at least one of a speech, a gesture, a wiring, and a touch, as means of communication for each of the plurality of users.

14. The method of claim 1, wherein the table comprises a user device field comprising at least one of a smart phone, a tablet personal computer (PC), a car, and a navigation system, as devices for each of the plurality of users.

15. The method of claim 1, wherein the table comprises a social networks field comprising at least one of a family, a friend, a follower, and a followee, as social relations for each of the plurality of users.

16. The method of claim 1, wherein the table comprises a social aspect field comprising at least one of credits, assets, and an authority, as social aspects for each of the plurality of users.

17. A server operating in a social network, wherein the server receives a search request from a first user among a plurality of users, provides the first user with contents owned by a second user, as a search result corresponding to the search request, by referring to the structured table, receives an additional search request from the first user, and provides the first user with additional contents owned by the second user, as a search result corresponding to the search request, by referring to the structured table.
